(19) United States
(12) Patent Application Publication
(10) Pub. No.: US 2020/0320572 A1
(43) Pub. Date: Oct. 8, 2020

(54) SYSTEM AND METHOD FOR COLLECTING INFORMATION BY USING DIGITAL RECOGNITION DEVICE

(71) Applicant: Sanghyub LEE, Gyeonggi-do (KR)

(72) Inventor: Sanghyub LEE, Gyeonggi-do (KR)

(21) Appl. No.: 16/641,948

(22) PCT Filed: Aug. 27, 2018
(86) PCT No.: PCT/KR2018/009880

§ 371 Date: Feb. 25, 2020

(30) Foreign Application Priority Data
Aug. 25, 2017 (KR) 10-2017-0108297

(51) Int. Cl. G06Q 30/02; G06K 19/04

(52) U.S. Cl. CPC G06Q 30/0258; G06Q 30/0273; G06K 19/042; G06Q 30/0267; G06Q 30/0277

(57) ABSTRACT

A system and method for collecting information by using a digital recognition device can collect advertisement catalogue information without disclosing customer information to an advertiser. The system may include: a tag information read unit configured to read tag information; a tag information input unit; a customer terminal configured to register personal information of a customer and a customer identification code; an advertiser terminal configured to generate an identification code (ID and P/W) based on personal information of an advertiser and an advertiser identification code; a Database configured to store the unique number given to the tag information read unit, the unique number of the tag information input unit, the personal information of the customer, the customer identification code, the identification code, the personal information of the advertiser, the advertiser identification code, an advertisement contents matching table, and the advertisement contents; and the digital information providing server.

### TECHNICAL FIELD

The present disclosure relates to a system and method for collecting information, which can collect catalogue information, advertisement flyers, promotion media or movie promotion videos and various videos (hereafter, referred to as ‘advertisement information’), which are produced to introduce a product or company, by using a digital recognition device such as an RFID card or QR code, in which the unique number information of a customer is contained, and more particularly, to a system and method for collecting information by using a digital recognition device, which enable a customer to frequently receive advertisement information without disclosing personal information of the customer to an advertiser, such that print media can be significantly reduced, and enable the customer to easily search and read advertisement information downloaded by the customer.

### BACKGROUND ART

In general, most advertisements for promoting products and companies are propagated through media, and the development and diversification of media result in various types of advertisements. The development and spread of the media result in flooding advertisements, and printed media still charge their own functions even though the media have been diversified and advanced. Since the printed media have been considered as media which are more logical and reliable than any other media, print advertisements could take over the advantages of the printed media. From this viewpoint, catalogue-type printed materials are used as means for introducing company and product information in many cases. In addition, A4 or A3-size print flyers are used as media for promoting various shows, movies and events.

In many cases, catalogues have an excellent advertisement effect in that they directly show customers the images of companies or products, and thus are distributed by exhibitions, expositions, seminars, real estate offices and the like. Since such catalogues make a favorable impression of products on customers, the catalogues tend to be gradually improved in quality. However, since the catalogues are printed with high-quality papers at high image resolution, it costs a lot of money to produce catalogues, which represents a burden on advertisers. In order to reduce a catalogue production cost, advertisers want to produce only the minimum quantity of catalogues. However, when many customers ask for catalogues, the advertisers need to produce a large quantity of catalogues with the burden of cost in many cases. Since printing companies show high costs for the minimum quantity, the advertisers always feel much pressure when producing catalogues. In particular, when a new product is developed and thus needs to be listed on a catalogue, the existing catalogue needs to be discarded, and a new catalogue needs to be produced.

Although a catalogue is important information recognition means to imprint a product of a specific company on customers' memories, the catalogue is only recognized as an advertisement, and tends not to be considered as a valuable material because the catalogue is given for free. Therefore, the catalogue may not make a satisfactory advertisement effect, compared to the production cost.

Other examples of the printed media for advertising a company's product include print flyers which can be produced at relatively low cost. Such print flyers are randomly distributed on the street or distributed to customers in a place given for advertisement. However, since customers tend not to receive the print flyers, the print flyers may not make a satisfactory advertisement effect either.

With the development of ICT (Information Communication Technology), many attempts to digitalize advertising printed materials have been made in order to reduce the production costs of catalogues while preventing the negative effect of printed media production. In most cases except a specific case, however, customers do not download electronic catalogue information for himself/herself, and it is not easy to deliver an electronic catalogue to a customer. Therefore, the electronic catalogue does not have a high utility value.

In order to provide an electronic catalogue, a customer's personal information needs to be acquired. However, since most customers who live in flooding advertisements are unwilling to disclose their information, it is difficult to distribute electronic catalogues. In particular, since indiscriminate advertisements are provided to customers through their emails or SNS, the customers tend to avoid advertising information, and thus may not receive advertisements which the customers really want to receive. Due to such a problem, the customers have the burden of disclosing their information to receive an advertisement, and thus tend to avoid receiving an advertisement.

### DISCLOSURE

### Technical Problem

Various embodiments are directed to a system and method for collecting information by using a digital recognition device, which can collect advertisement information without disclosing customer information to an advertiser.

Also, various embodiments are directed to a system and method for collecting information by using a digital recognition device, which enable a customer to receive advertisement information through a receiving method such as an app, email, alarm, fax or SNS (Social Network Sites), designated when the customer signed up for membership, by touching a digital information reader provided by an advertiser with a digital recognition device such as an RFID or QR code, and automatically store the received information in a classified folder of a homepage server of the customer, such that the customer can easily search and watch the downloaded advertisement information.

### Technical Solution

In an embodiment, a system for collecting information by using a digital recognition device may include: a tag information read unit given a unique number for itself, and configured to read tag information; a tag information input unit having a unique number for itself and personal identification information for receiving digital advertisement information, registered therein; a customer terminal configured to register personal information of a customer and a customer identification code (ID and P/W), which are required for membership sign-up, in a digital information providing server; an advertiser terminal configured to generate an identification code (ID and P/W) based on personal information of an advertiser and an advertiser identification code (ID and P/W), which are required for membership sign-up to provide advertisement information to the customer, the unique number of the tag information read unit, and advertisement information contents owned by the advertiser, register the identification code in the digital information providing server, upload the advertisement information contents to the digital information providing server, and deposit an amount of money for advertisement information transmission cost into the digital information providing server; a DB (Database) configured to store the unique number given to the tag information read unit, the unique number of the tag information input unit, the personal information of the customer, the customer identification code (ID and P/W), the identification code (ID and P/W) given to the advertisement information, the personal information of the advertiser, the advertiser identification code (ID and P/W), an advertisement contents matching table for matching the advertisement information identification code with an index table of advertisement contents, and the advertisement contents; and the digital information providing server configured to register the identification codes of the customer and the advertiser, the unique number of the card reader and the identification code of the advertisement information therein, assign the unit number of the tag information input unit to the customer, receive the unique number of the tag information read unit, the identification code of the advertisement information registered in the tag information read unit, the unique number of the tag information input unit, and the personal identification code, as the customer touches the tag information read unit with the tag information input unit, request a customer information list from the DB to check whether the unique number of the tag information input unit and the customer identification code which are provided by the tag information read unit are matched with a customer ID, retrieve advertisement information matched with the advertisement information identification code from the DB, provide the retrieved advertisement information to the customer, and deduct an advertisement cost from the amount of money deposited by the advertiser.

The system may further include a tag information input unit registration reader configured to assign the unique number of the tag information input unit and register the unique number in the digital information providing server, when the customer requests member registration.

The tag information input unit registration reader may be any one selected among an RFID reader, an NFC (Near Field Communication) reader, a barcode reader, a QR code reader, an iris recognition device, a fingerprint recognition device and a hologram recognition device.

The digital information providing server may include: an advertiser member registration unit configured to receive an advertisement request from the advertiser terminal and register an advertiser member; an amount deposit unit configured to request the advertiser to deposit an amount of money for advertisement, in order to charge the advertiser for advertisement provision after the advertiser member registration is completed by the advertiser member registration unit; a contents upload unit configured to upload an advertisement information identification code (ID and P/W) and advertisement information contents corresponding to the advertisement information identification code, after the amount deposit unit checks that the amount of money is deposited; a matching unit configured to check whether a customer identification code stored in the DB is matched with the personal identification code and the unique number of the tag information input unit, received through the tag information read unit, as the customer touches the tag information read unit with the tag information input unit, and check whether the advertisement contents matching table stored in the DB is matched with the unique number of the tag information read unit and the advertisement information identification code; an advertisement contents transmitting unit configured to retrieve requested advertisement information contents from the advertisement contents matching table of the DB, and transmit the retrieved advertisement information contents to the customer, when the matching unit checks that the advertisement contents matching table is matched with the unique number of the tag information read unit and the advertisement information identification code; a customer member registration unit configured to perform member registration according to a member registration request of the customer; a tag information input unit registration unit configured to register the unique number of the tag information input unit when the customer signs up for membership, and register the tag information input unit through an tag information input unit registration reader by matching the unique number of the tag information input unit with an authentication number provided to the customer terminal; a download list storage unit configured to store advertisement information which is downloaded as the customer touches the tag information read unit with the tag information input unit, and classify the advertisement information for each information type; a central control unit configured to store, in the DB, the identification codes (ID and P/W) given during the membership sign-up of the advertiser and the customer, the unique number of the tag information input unit, the unique number of the tag information read unit, the advertisement information identification code, and the advertisement contents matching table in which the advertisement contents corresponding to the advertisement information identification code are indexed, and perform a series of control processes of receiving the tag information input unit unique number provided from the tag information read unit, the personal identification code, the unique number of the tag information read unit, and the advertisement information identification code, check whether the customer identification code stored in the DB is matched with the unique number of the tag information input unit and the personal identification code, and transmit advertisement information to the customer; and a charge unit configured to perform a charge command from the central control unit when the advertisement information is transmitted to the customer. The digital information providing server may further include an alarm unit configured to perform counting whenever the tag information read unit is touched with the tag information input unit, and inform the advertiser terminal of the count value.

In an embodiment, a method for collecting information by using a digital recognition device may include: a first step of requesting, by the customer terminal, a digital information providing server to register individual member information; a second step of selecting an advertisement information receiving method and registering the selected method in the digital information providing server, when the member information of the customer is registered; a third step of registering a tag information registration unit unique number in the digital information providing server, when the member information of the customer is registered; a fourth step of requesting, by an advertiser terminal, the digital information providing server to register advertiser member information, requesting advertisement, and depositing an amount of money for advertisement; a fifth step of inputting the unique number of a tag information read unit, an advertisement information recognition code, the unique number of a tag information input unit, and a personal identification code, stored in the tag information read unit, to the digital information providing server, when the tag information read unit is touched with the tag information input unit carried by a customer, wherein the digital information providing server determines whether customer information stored in a DB is matched with the tag information input unit unique number and the personal identification code; and a sixth step of transmitting an advertisement contents file to a storage place designated by the customer, when the customer information is matched with the tag information input unit unique number in the fifth step.

The first step comprises: a first process of downloading, by the customer, a member registration app to register the member information, when the customer uses a mobile terminal, or connecting to the server to register the member information, when the customer uses a PC (Personal Computer); a second process of inputting, by the customer, the tag information input unit unique number, matched with an authentication number provided to the customer terminal, to a tag information input unit registration reader, when the customer registers the member information; and a third process of registering the tag information input unit unique number, provided from the tag information input unit registration reader, in the digital information providing server, and storing the tag information input unit unique number in the DB.

The third step may include downloading a dedicated management program, and executing the dedicated management program to decide a catalogue receiving method. The catalogue receiving method may include designating a receiving path through which a catalogue is transmitted to a storage place selected among an email, SNS and a widget program.

The fourth step may include: a fourth process of transmitting, by the advertiser terminal, an advertisement request to the digital information providing server, and then giving an identification code (ID and P/W) to advertisement information contents; a fifth process of registering the identification code (ID and P/W) of the advertisement information contents and the unique number given to the tag information read unit in the digital information providing server; and a sixth process of depositing the amount of money to be consumed as an advertisement fee, and uploading the advertisement information contents.

The fifth step may further include: a seventh process of receiving member information (ID and P/W) according to a member registration request from the customer, performing member registration, and storing the member information (ID and P/W) in the DB; an eighth process of assigning a tag information input unit unique number when the member registration of the customer is completed, and matching the tag information input unit unique number with an authentication number provided from the customer to register the tag information input unit unique number in the server; a ninth process of completely registering a tag information read unit identification code provided from the advertiser terminal, and storing advertisement contents, uploaded by the advertiser, in the DB; a tenth process of transmitting, by the tag information read unit, the unique number thereof, an identification code given to the advertisement information, the tag information input unit unique number and the personal identification code to the server, when the customer touches the tag information read unit with the tag information input unit; an 11th process of checking whether the received tag information input unit unique number and the received personal identification code are matched with the customer information, checking an advertisement contents file from an advertisement contents matching table when the tag information input unit unique number and the personal identification code are matched with the customer information, transmitting the advertisement contents to a storage place designated by the customer, transmitting the advertisement contents to a storage place designated by the customer, and transmitting an advertisement service termination text message to the tag information read unit when there is no advertisement contents file; a 12th process of performing counting by the touch count of the customer, and deducting an amount corresponding to the touch count from the amount of money deposited by the advertiser; and a 13th process of checking the balance of the tag information read unit, controlling the tag information read unit to generate an alarm when the balance is not enough, and providing the advertiser with information indicating that money needs to be additionally deposited.

The tenth process may further include a process of checking, by the server, whether a customer ID is matched with the tag information input unit unique number, checking a receiving method desired by the customer, and transmitting advertisement information.

### Advantageous Effects

The system and method in accordance with the embodiments of the present disclosure have the following effects.

First, since a customer can receive advertisement contents information such as a catalogue, video and image only by touching a card reader with an RFID card, it is possible to significantly reduce paper print materials used for advertisement.

Second, since a customer can receive only desired advertisement contents information without disclosing his/her information to an advertiser, the personal information can be reliably protected.

Third, a customer can install a dedicated management program in a customer terminal and download advertisement contents anytime and anywhere. Since downloaded files can be automatically classified, the files can be efficiently managed. Fourth, since contents information can be automatically received even though a customer does not receive a printed material from an exhibition booth or catalogue distribution place during an exhibition or exposition, the customer can conveniently watch the exhibition or exposition.

### BRIEF DESCRIPTION OF DRAWINGS

FIG. 1 is a diagram schematically illustrating a system for providing a catalogue on-line service according to the related art.

FIG. 2 is a conceptual view illustrating a system for collecting information by using a digital recognition device in accordance with an embodiment of the present disclosure.

FIG. 3 is a configuration diagram illustrating the system for collecting information by using a digital recognition device in accordance with the embodiment of the present disclosure.

FIG. 4 is a detailed configuration diagram illustrating a digital information providing server which is a main part of the system in accordance with the embodiment of the present disclosure.

FIG. 5 is a screen showing a configuration of the digital information providing server in accordance with the embodiment of the present disclosure.

FIG. 6 is a diagram illustrating a catalogue download program of a customer in accordance with the embodiment of the present disclosure.

FIG. 7 is an overall flowchart illustrating a method for collecting information by using a digital recognition device in accordance with an embodiment of the present disclosure.

FIG. 8 is a detailed flowchart illustrating a detailed process of a customer terminal in the method for collecting information by using a digital recognition device in accordance with the embodiment of the present disclosure.

FIG. 9 is a detailed flowchart illustrating a detailed process of an advertiser terminal in the method for collecting information by using a digital recognition device in accordance with the embodiment of the present disclosure.

FIGS. 10a-1, 10a-2 and 10b are detailed flowcharts illustrating a detailed process of a server in the method for collecting information by using a digital recognition device in accordance with the embodiment of the present disclosure.

### MODE FOR INVENTION

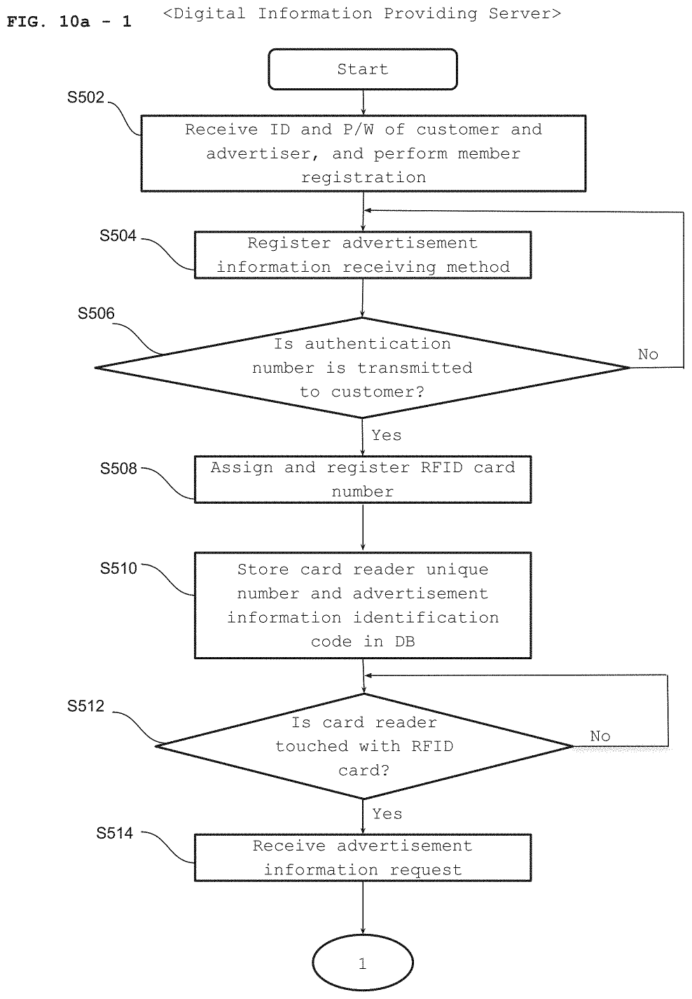

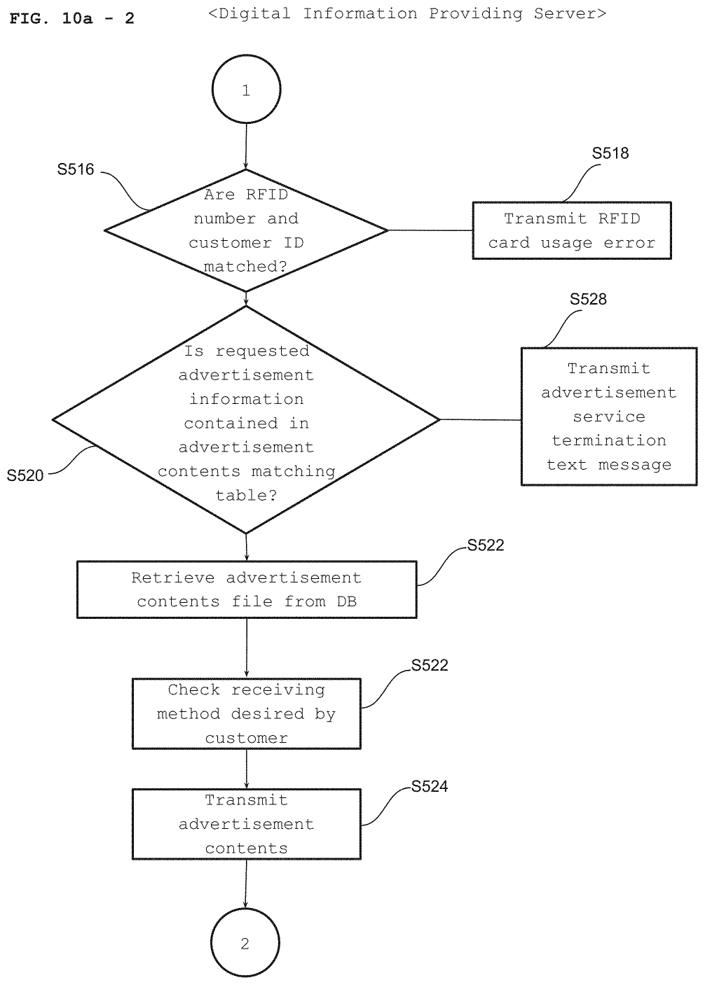

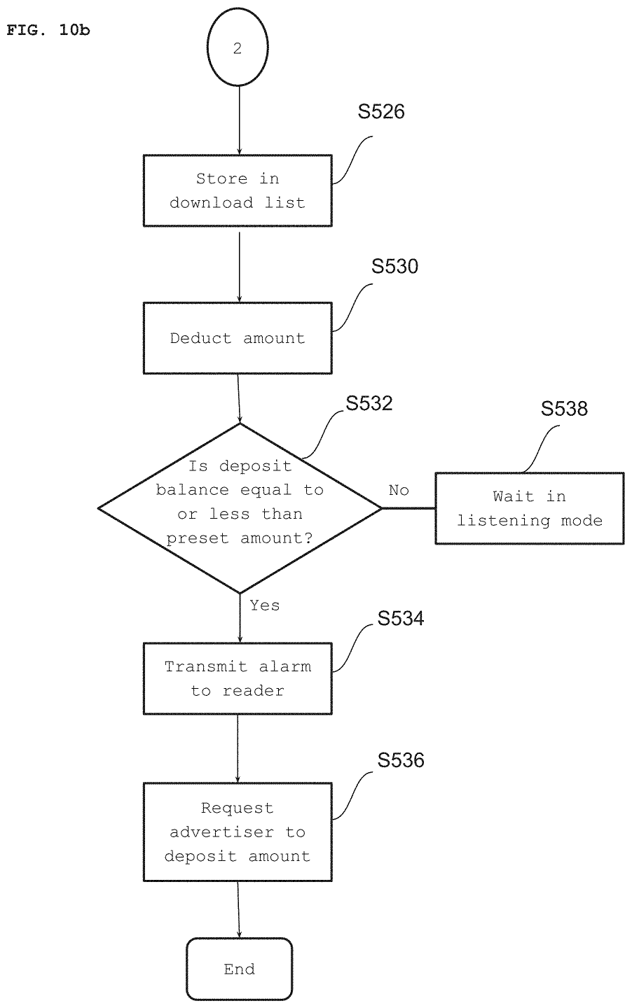

Specific features and other advantages of a system and method for collecting information by using a digital recognition device in accordance with an embodiment of the present disclosure will be clarified through descriptions of preferred embodiments with reference to FIGS. 2 to 10.

The system and method for collecting information by using a digital recognition device in accordance with the embodiment of the present disclosure are implemented to enable a customer to receive advertisement information provided by an advertiser, without disclosing his/her personal information to the advertiser. Before the present disclosure is described, the definition and function of an electronic catalogue corresponding to advertising information will be briefly described.

The electronic catalogue refers to a system that electronically displays information on a certain product and information on trade of the product, and is constructed by configuring various properties of the product and overall information as a database according to the standard regulation, the overall information including information on production and order receiving/placing. A customer can see the information of the product through the electronic catalogue, and search and compare desired products. Furthermore, through the electronic catalogue, the customer can also search complementary/substitute products, and obtain information on companies which handle such products. Such an electronic catalogue may be widely used in not only EDI (Electronic Data Interchange) which is the base of B2B (Business-to-Business) transactions, but also Internet shopping malls and the like.

A purchaser and a provider may transact with each other through an electronic catalogue. Purchasers can efficiently compare and search items through an electronic catalogue system which is standardized and well made, and thus easily find an inexpensive and good product. When a provider has an electronic catalogue system containing clearly organized and accurate product information, the electronic catalogue system can reduce a promoting and marketing cost, thereby contributing to improvement in sales.

Based on the above-described functions of the electronic catalogue, the concept of the present disclosure will be described with reference to FIG. 2.

FIG. 2 is a conceptual view illustrating a system for collecting information by using a digital recognition device in accordance with an embodiment of the present disclosure.

As illustrated in FIG. 2, advertisement information which is created to promote a company or a new product of the company is given an identification code (ID and P/W), and an RFID (Radio-Frequency Identification) card reader 10 is given a unique number, and has advertisement information identification codes registered therein.

Through a terminal, personal information of a customer/advertiser and advertisement information are inputted to a digital information providing server 4 and stored in a DB (Database) 6. Furthermore, an RFID card 8 matched with the personal information of the customer is registered in the digital information providing server. Then, when the card reader 10 is touched with the RFID card 8 given to the customer, the digital information providing server 4 may read the advertisement information of the advertiser from the DB 6, and transmit the read information to a storage place 12 designated by the customer, for example, an information storage place such as an email, SNS or widget.

In the present disclosure, the advertisement information includes product details as well as all digital data such as catalogues, images, videos and 3D files for introducing products and companies.

Based on such a concept of the advertisement information, the configuration for implementing the present disclosure will be described in more detail as follows.

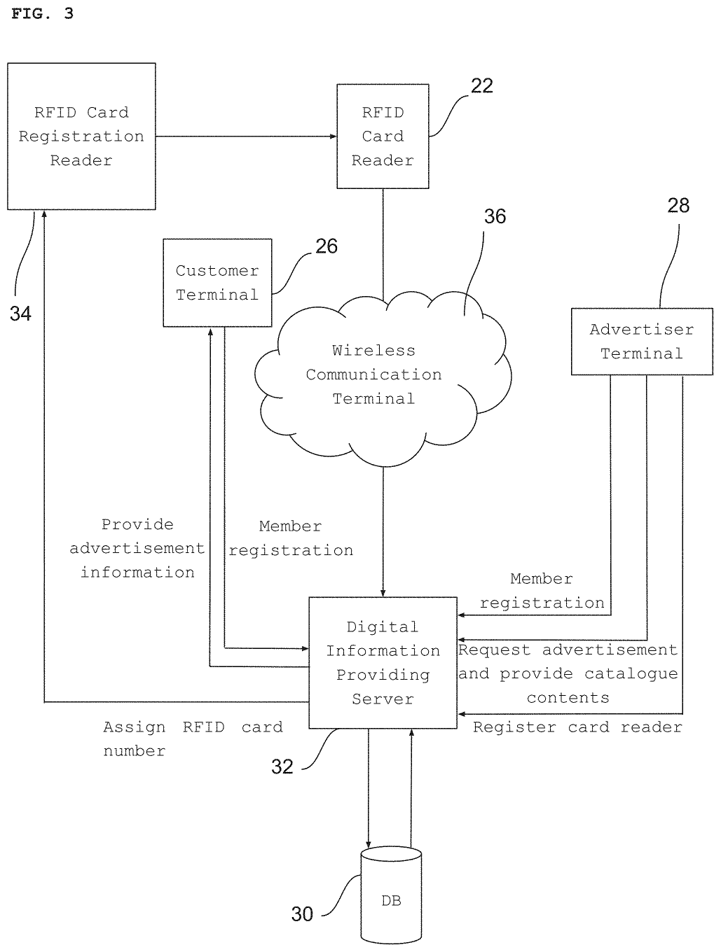

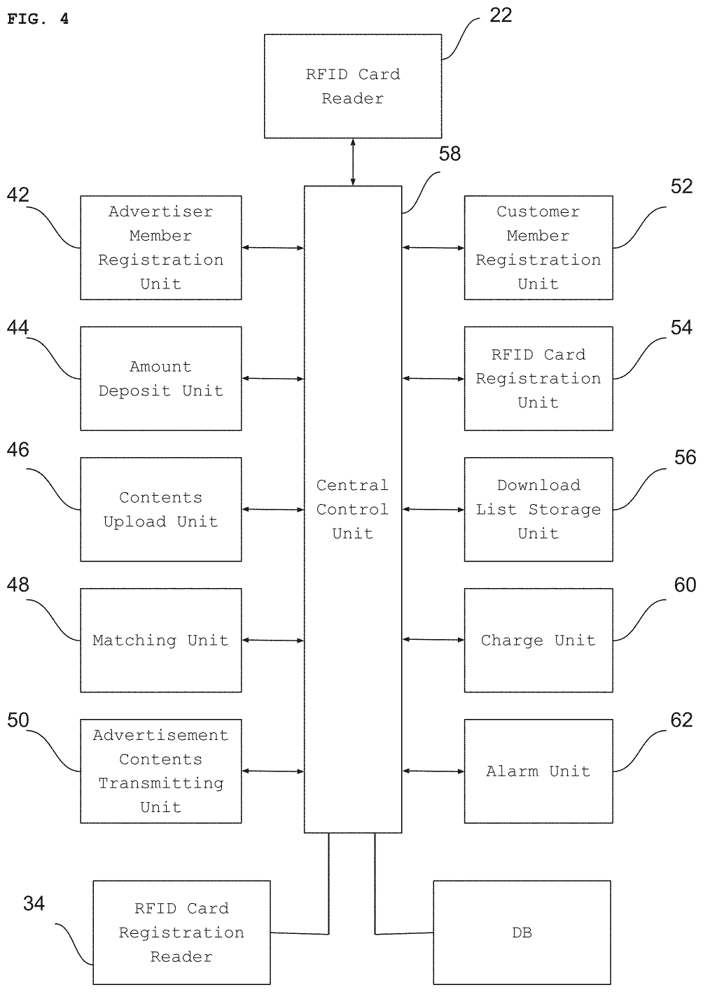

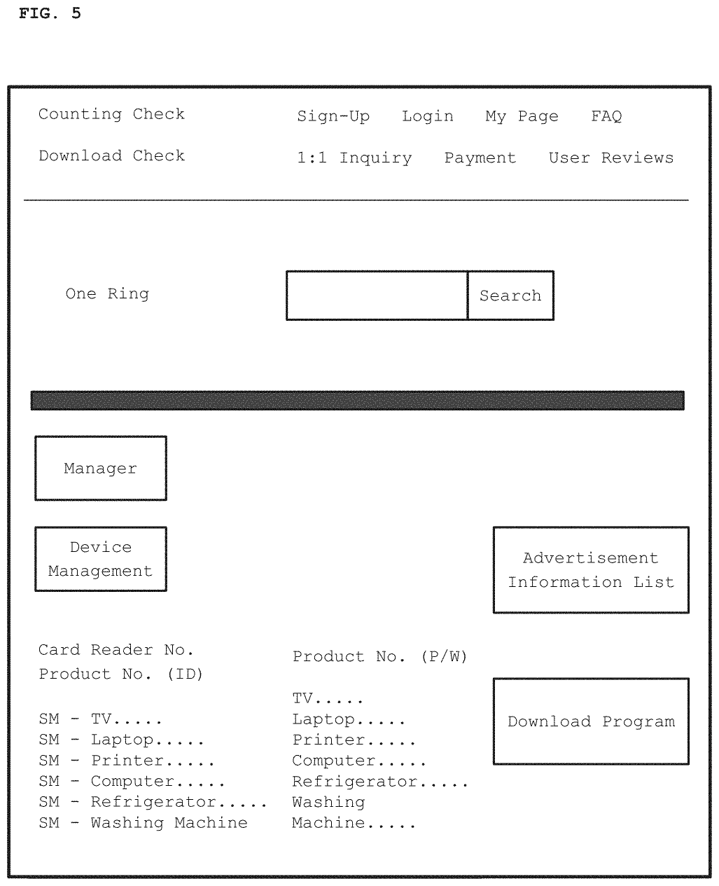

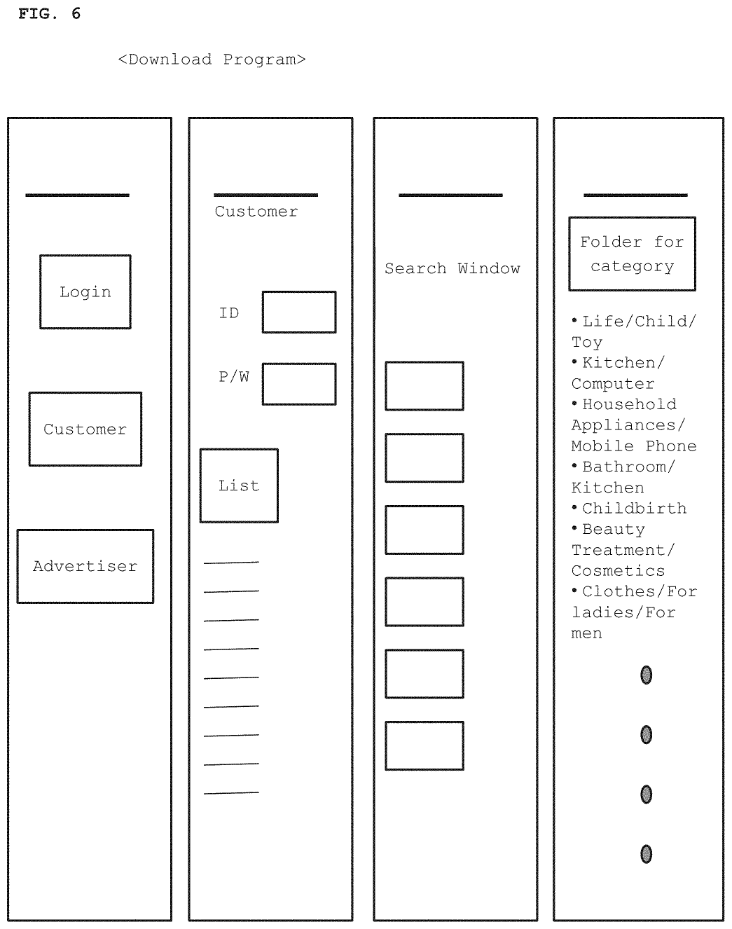

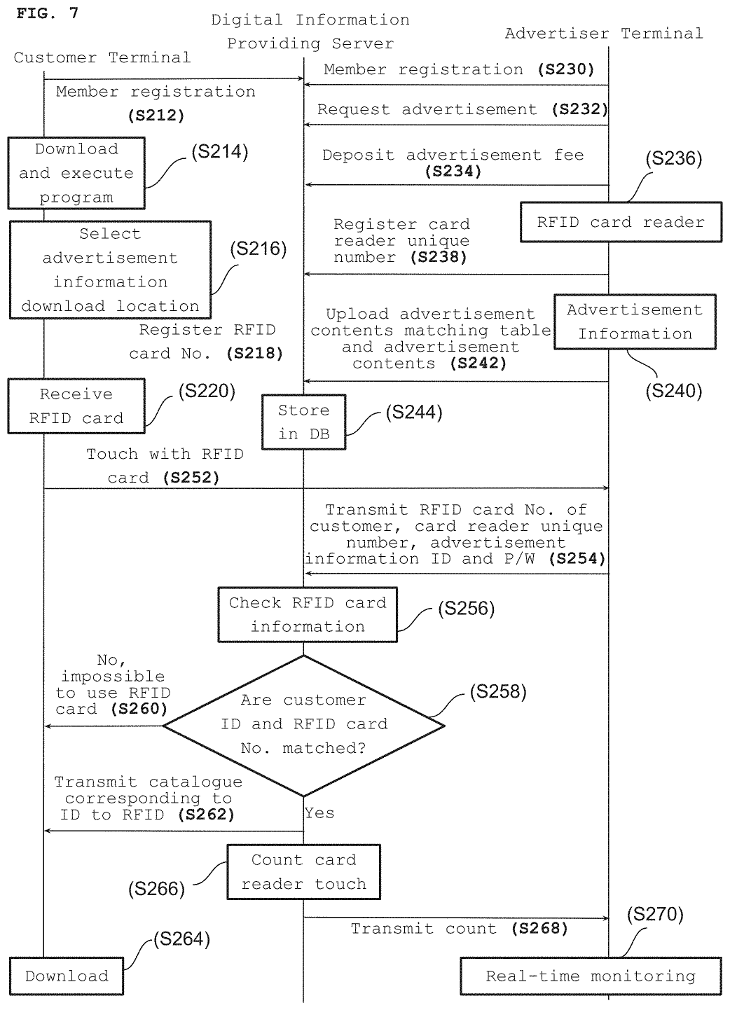

FIG. 3 is a configuration diagram illustrating the system for collecting information by using a digital recognition device in accordance with the embodiment of the present disclosure, FIG. 4 is a detailed configuration diagram illustrating a digital information providing server which is a main part of the system in accordance with the embodiment of the present disclosure, FIG. 5 is a screen showing a configuration of the digital information providing server in accordance with the embodiment of the present disclosure, and FIG. 6 is a diagram illustrating a catalogue download program of a customer in accordance with the embodiment of the present disclosure.

As illustrated in FIG. 3, the system includes an RFID card reader (hereafter, referred to as ‘card reader’) 22, a customer terminal 26, an advertiser terminal 28, a DB 30, a digital information providing server 32 and an RFID card registration reader 34. The card reader 22 is given a unique number for itself, and reads tag information. The RFID card contains a personal identification code (ID and P/W) matched with personal information of a customer and the unique number (RFID card number) of the customer, the personal information including the sex, phone number, email and SNS of the customer. The customer terminal 26 registers, in a digital information providing server, the personal information (for example, sex, phone number, email and SNS) of the customer, which is required for membership sign-up in order for the customer to receive advertisement information, and a customer identification code (ID and P/W) matched with the personal information of the customer. The advertiser terminal 28 generates an identification code (ID and P/W) based on personal information (for example, company name, phone number, address and e-mail address) of an advertiser, which is required for membership sign-up to provide advertisement information to a customer, an advertiser identification code (ID and P/W), the unique number of the card reader 22, and advertisement information contents owned by the advertiser, registers the identification code in the digital information providing server, uploads the advertisement information contents to the digital information providing server, and deposits an amount of money for advertisement information transmission cost in the digital information providing server. The DB 30 stores an identification number given to the card reader 22, an identification number of the RFID card, the personal information (sex, phone number, email and SNS) of the customer, which is registered during the customer membership sign-up, the customer identification code (ID and P/W), an identification code (ID and P/W) given to advertisement information, the personal information (sex, phone number, email and SNS) of the advertiser (individual or corporate body), which is registered during the advertiser membership sign-up, the advertiser identification code (ID and P/W), an advertisement contents matching table for matching an advertisement information identification code with an index table of advertisement contents, and the advertisement contents. The digital information providing server 32 registers the identification codes of the customer and the advertiser, the unique number of the card reader and the identification code of the advertisement information, assigns an RFID card number to the customer, receives the unique number (reader No.) of the card reader 22, the identification code of the advertisement information registered in the card reader 22, the unique number (RFID No.) of the RFID card, and the personal identification code, as the customer touches the card reader 22 with the RFID card, and checks whether the RFID card number and the personal identification code which are provided by the card reader 22 are matched with a customer ID, based on a customer information list stored in the DB 30. Furthermore, the digital information providing server 32 retrieves advertisement information corresponding to the advertisement information identification code from the DB, provides the advertisement information to the customer, and deducts the advertisement fee from the amount of money deposited by the advertiser. The RFID card registration reader 34 reads the RFID card number when the customer requests member registration, and registers the read RFID card number in the digital information providing server 32.

The unique number of the card reader 22 and the advertisement information identification code and the RFID card unique number, registered in the card reader 22, are inputted to the digital information providing server 32 through a wireless communication network 36 or a wired communication network (not illustrated). The card reader 22 is connected to a GPS (Global Positioning System) 38 for providing position information of the RFID card to the digital information providing server 32.

The card reader 22 serving as a tag information reader may be any one selected from an RFID reader, an NFC (Near Field Communication) reader, a barcode reader, a QR code reader, an iris recognition device, a fingerprint recognition device and a hologram recognition device. The RFID card is suggested as a tag information input unit. In addition, however, the tag information input unit may be any one selected from NFC, a barcode, a QR code, iris recognition, fingerprint recognition and hologram, which correspond to the types of the above-described readers. For example, when a fingerprint is registered as the tag information input unit, a fingerprint recognition device may be used as the card reader.

The unique number of the RFID card, stored in the DB 30, is assigned through the digital information providing server 32, and registered through the RFID card registration reader 34 when a customer signs up for membership. When a customer requests advertisement information, the RFID card number provides a function capable of checking whether the RFID card number and the customer identification code (ID and P/W) are matched with a customer ID through the customer information list stored in the DB 30. That is, since the RFID card is registered through authentication when the customer signs up for membership, only one RFID number is present for one customer ID. Therefore, when the customer touches the card reader 22 with the RFID card, the digital information providing server 32 checks whether the customer is a member, by determining whether the unique number of the RFID card and the personal identification code (ID and P/W) are matched with the customer ID stored in the DB 30. When the check result indicates that the customer is a member, the digital information providing server 32 transmits an advertisement information file provided by the advertiser to the customer.

As illustrated in FIG. 4, the digital information providing server 32 for controlling a series of processes of transmitting advertisement information to a customer includes an advertiser member registration unit 42, an amount deposit unit 44, a contents upload unit 46, a matching unit 48, an advertisement contents transmitting unit 50, a customer member registration unit 52, an RFID card registration unit 54, a download list storage unit 56, a central control unit 58, a charge unit 60 and an alarm unit 62. The advertiser member registration unit 42 receives an advertisement request from the advertiser terminal 28, and registers an advertiser member. The amount deposit unit 44 requests the advertiser to deposit an amount of money for advertisement, in order to charge the advertiser with a commission for advertisement after the advertiser member registration is completed by the advertiser member registration unit 42. The contents upload unit 46 uploads an advertisement information identification code (ID and P/W) and advertisement information contents corresponding to the advertisement information identification code, after the amount deposit unit 44 checks that the amount of money is deposited. The matching unit 48 checks whether the customer ID stored in the DB 30 is matched with the RFID card number and the personal identification number, received through the card reader 22, as the customer touches the card reader 22 with the RFID card, and checks whether the advertisement contents matching table stored in the DB is matched with the unique number of the card reader and the advertisement information identification code. The advertisement contents transmitting unit 50 retrieves the requested advertisement information contents from the advertisement contents matching table of the DB 30, and transmits the retrieved advertisement information contents to the customer, when the matching unit 48 checks that the advertisement contents matching table is matched with the unique number of the card reader and the advertisement information identification code. The customer member registration unit 52 performs member registration according to a member registration request of the customer. The RFID card registration unit 54 assigns an RFID card number when the customer signs up for the membership, and registers the RFID card number through the RFID card registration reader 34 by matching the RFID card number with an authentication number provided to the customer terminal 26. The download list storage unit 56 stores advertisement information which is downloaded as the customer touches the card reader 22 with the RFID card, and classifies the advertisement information for each information type. The central control unit 58 stores, in the DB 30, the identification codes (ID and P/W) given during the membership sign-up of the advertiser and the customer, the RFID card number, the card reader unique number, the advertisement information identification code (ID and P/W), and the advertisement contents matching table in which the advertisement contents corresponding to the advertisement information identification number are indexed, and performs a series of control processes of receiving the RFID card number provided from the card reader 22, the personal identification code (ID and P/W), the card reader unique number, and the advertisement information identification code registered in the card reader 22, checking whether the customer personal information stored in the DB 30 is matched with the RFID card number and the personal identification code (ID and P/W), and transmitting advertisement information to the customer. The charge unit 60 performs a charge command from the central control unit when the advertisement information is transmitted to the customer. The alarm unit 62 performs counting whenever the card reader 22 is touched with the RFID card, and informs the advertisement terminal of the count value.

The alarm unit 62 is a selective function for enabling the advertiser to recognize an advertisement transmission count when the advertiser requests an advertisement, and an alarm device is mounted on the card reader. Therefore, the advertisement transmission count is transmitted to the advertiser terminal 28 through the central control unit 58, depending on whether the card reader is touched with the RFID card. When no alarm device is mounted on the card reader 22, the advertisement transmission count may be checked through a counting check menu displayed on the main screen of the digital information providing server 32.

FIG. 5 illustrates the main screen of the digital information providing server 32 configured in the above-described manner. As illustrated in FIG. 5, sign-up, login, my page, FAQ, 1:1 inquiry, payment and user reviews are displayed as main menus. In addition, an advertisement information list menu and a download program menu are displayed. When the advertisement information list menu is clicked, the requested advertisement information list may be displayed.

In a manager mode of the digital information providing server 32, a device management function and an advertisement information management function for each product can be performed. In the case of a shopping mall which handles various products, the unique number of a card reader may be registered for management and an identification code (ID, P/W) given to each product may be registered in the card reader for management, through the device management function. Furthermore, in the case of a mall with nationwide chain stores, one manager may register products distributed throughout the nation for each of card readers, and collectively manage the products. In other words, card readers whose serial numbers are registered may be distributed to the nationwide chain stores, and the ID and P/W of one product may be registered in the serial numbers of the card readers. In this case, when a customer touches the card reader in any chain store, the information of the registered product may be transmitted to the customer, and the manager may check the count value. For example, suppose that a shopping mall has 100 stores throughout the nation, and 100 card readers to which unique numbers 1 to 100 are given are installed in the 100 stores, respectively. In this case, a manager registers one TV product (ID) and a series item (P/W) with the unique numbers 1 to 100 of the card readers. Thus, when the card readers are touched with RFID cards in several stores at the same time (or with time differences), the count value for one TV product is recorded, and charging is performed by the count value. The manager can check this process through the count value on the count check menu, thereby easily performing the product management. In particular, when the advertiser needs no more advertisements because the TV product has been discontinued, and intends to propagate the advertisement information on a new product, for example, a notebook to customers, the advertiser may change the advertisement information identification code (ID and P/W) of the TV, registered with the unique numbers 1 to 100 of the card readers, to the advertisement information identification code (ID and P/W) of the notebook.

As illustrated in FIG. 6, a dedicated management program has a customer or advertiser menu, is configured to display an ID and P/W input menu and a list when the customer menu is clicked, and includes a search window menu and a folder for each category. Therefore, when a customer logs in, a list downloaded to the customer is displayed. Then, when the customer wants to find a file which the customer tries to see, the customer may input an information-type keyword to the search window menu, in order to find the corresponding file.

Next, the process of the system having the above-described configuration in accordance with the embodiment of the present disclosure will be described in detail with reference to FIGS. 7 to 10.

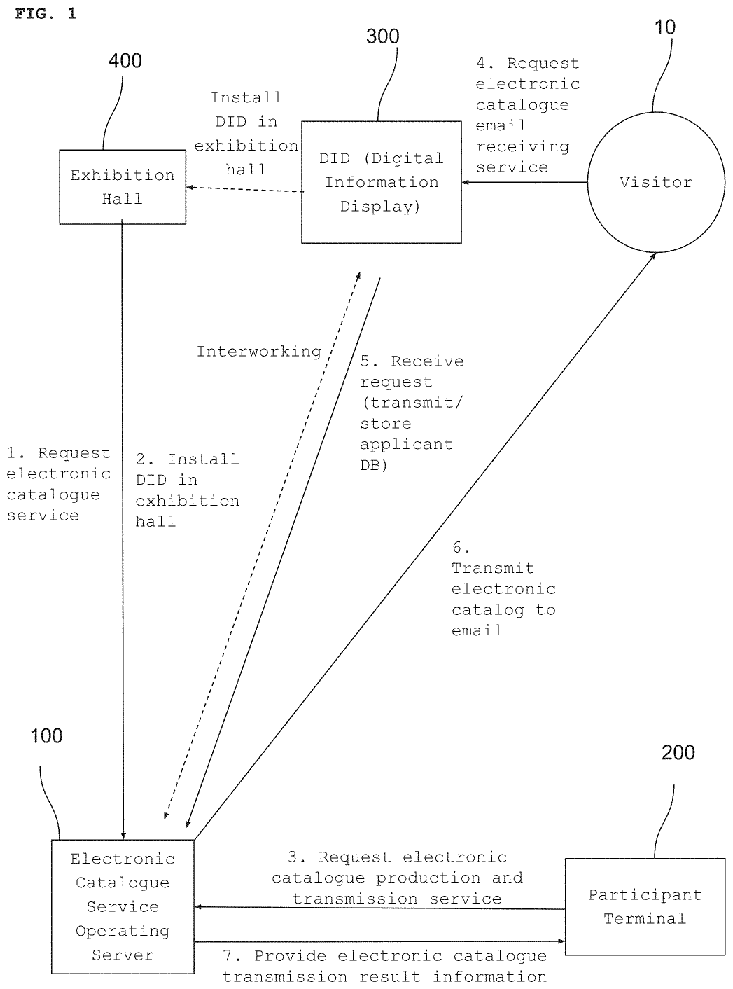

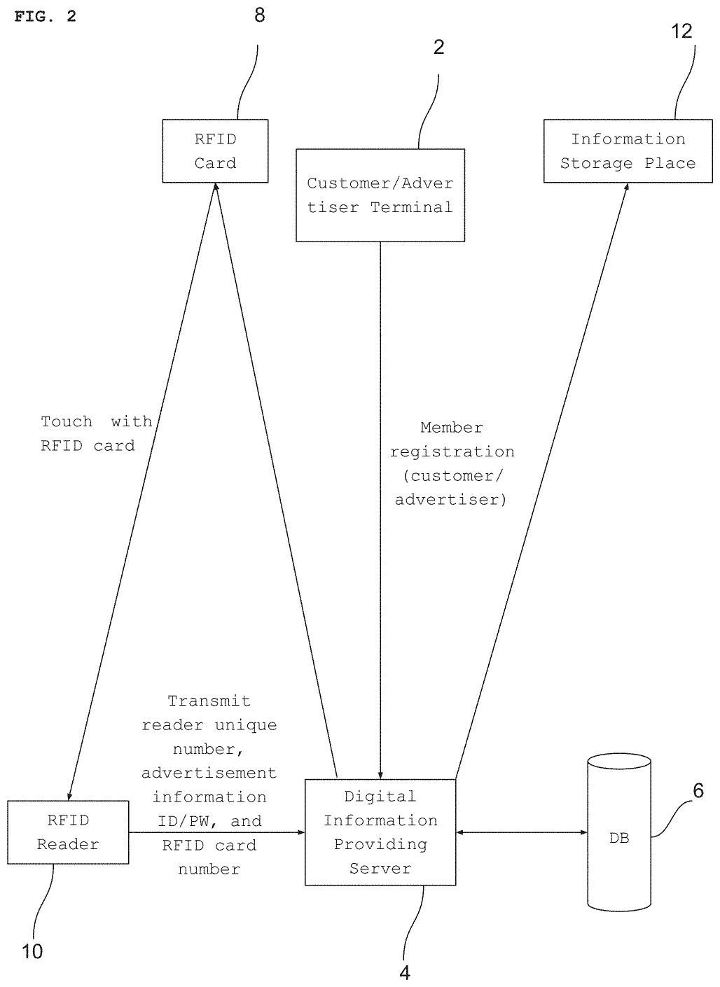

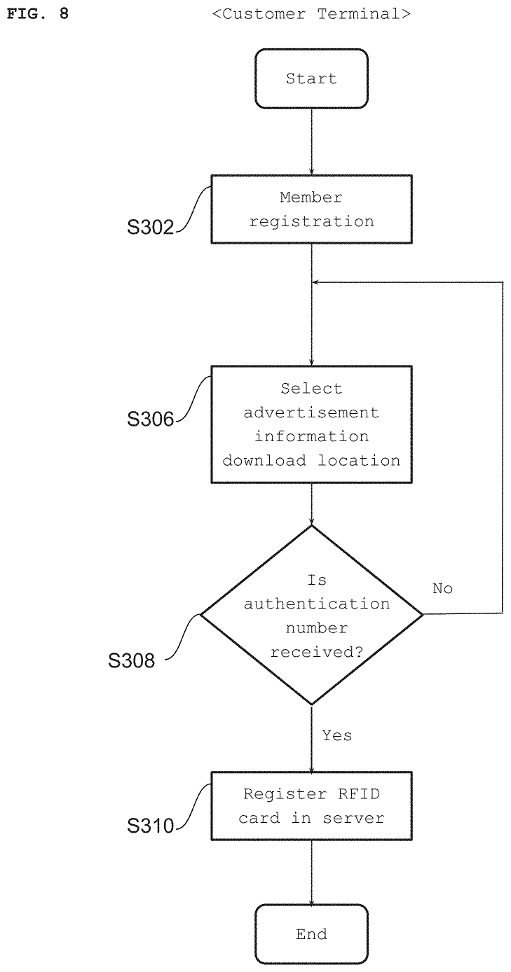

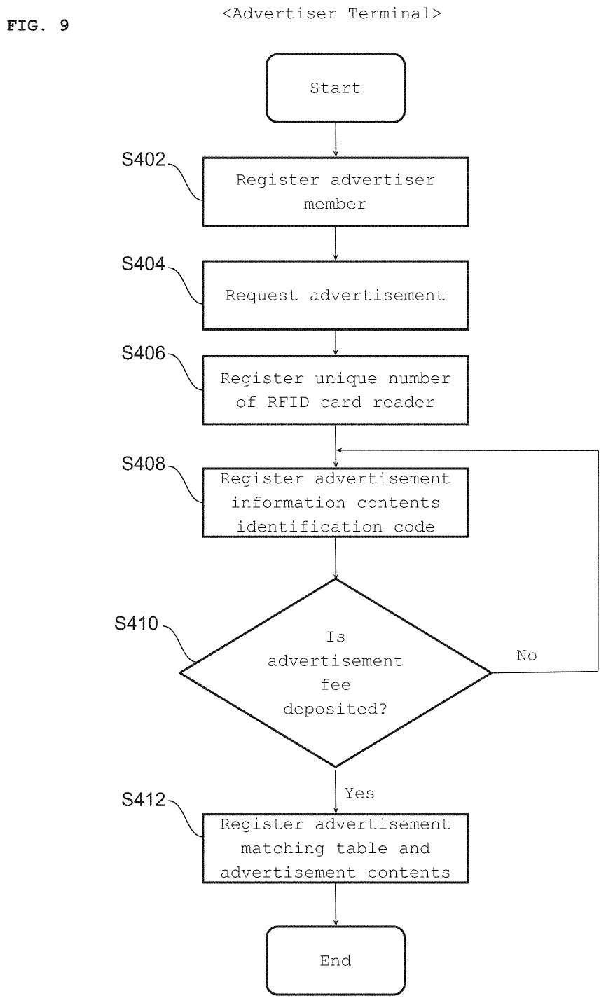

FIG. 7 is an overall flowchart illustrating a method for collecting information by using a digital recognition device in accordance with an embodiment of the present disclosure, FIG. 8 is a detailed flowchart illustrating a detailed process of a customer terminal in the method for collecting information by using a digital recognition device in accordance with the embodiment of the present disclosure, FIG. 9 is a detailed flowchart illustrating a detailed process of an advertiser terminal in the method for collecting information by using a digital recognition device in accordance with the embodiment of the present disclosure, and FIGS. 10a-1, 10a-2 and 10b are detailed flowcharts illustrating a detailed process of a server in the method for collecting information by using a digital recognition device in accordance with the embodiment of the present disclosure.

As illustrated in FIG. 7, a customer inputs personal information to the digital information providing server 32 through the customer terminal 26 and applies for membership, in step S212. Then, the customer downloads and executes a dedicated management program (including an app) provided by a server operating company, and selects an advertisement information receiving method and registers the selected method in the digital information providing server 32, in steps S214 and S216. According to the catalogue information receiving method, a receiving path may be designated so as to be connected to an e-mail, SNS, widget or the like in the dedicated management program in accordance with the embodiment of the present disclosure.

When the member registration is completed, an authentication number is transmitted to the customer's mobile phone. A server administrator checks the authentication number transmitted to the customer, registers an RFID card number in the RFID card registration reader 34, and then provides the RFID card to the customer in step S218 and S220. Through such a procedure, the ID and P/W of the customer is matched with the registered RFID card, and these pieces of information are stored in the DB.

The server operating company may provide the RFID card for free to only customers registered as members, or issue the RFID card at a predetermined price such that a customer purchases the RFID card in person.

In the embodiment of the present disclosure, the method in which a customer signs up for membership and then registers and receives an RFID card on the spot where the RFID card is issued has been described. However, the method for receiving an RFID card is not limited thereto, and a customer may receive the RFID card through various methods. For example, when a customer connects to the server through a personal PC terminal, signs up for membership, and transmits an authentication number to the server, the server may check the authentication number, register an RFID card, and provide the RFID card to the customer by mail. For another example, when a customer signs up for membership through a mobile terminal, receives an authentication number, and provides the authentication number to a server administrator, the server administrator may register an RFID card by recording the authentication number to an RFID registration field of the server and then provide the RFID card to the customer, or scan an authentication number registered in the mobile terminal of the customer through a registration reader and then provide the RFID card to the customer. When the authentication number is scanned through the registration reader, the authentication number is transmitted as a barcode to the mobile terminal of the customer. For still another example, when a customer purchases an RFID card in a general shop, the customer may connect to the server, input a pin number (different from the RFID card number) imprinted on the RFID card, and transmit the pin number to the digital information providing server 32. Then, the server may immediately register the pin number such that the customer can use the RFID card.

The advertiser terminal 28 requests the digital information providing server 32 to register member information, and requests advertisement, in steps S230 and S232. The advertiser deposits an amount of money to be consumed as an advertisement fee, in step S234, and registers the unique number of the RFID card reader 22 in the digital information providing server 32 in steps S236 and S238. Furthermore, the advertiser gives an identification number (ID and P/W) to advertisement information contents, registers the identification number in the card reader 22, and uploads an advertisement contents matching table and an advertisement contents file to the digital information providing server 32, in steps S240 and S242. The advertisement contents matching table includes the card reader unique number, the advertisement information contents identification code and the advertisement contents file which are recorded therein. The uploaded advertisement contents file and advertisement contents matching table are stored in the DB in step S244.

When the customer touches the card reader 22 with the RFID card after the information of the customer and the advertiser is completely registered in the digital information providing server 32, the unique number of the card reader and the advertisement information identification code, the RFID card number and a personal identification code, which are registered in the card reader, are inputted to the digital information providing server 32 in step S252 and S254. The digital information providing server 32 may determine whether a customer ID stored in the DB is matched with the RFID card number and the personal identification code, in step S256. When the determination result indicates that the customer ID stored in the DB is not matched with the RFID card number and the personal identification code, the digital information providing server 32 determines that the RFID card cannot be used, in steps S258 and S260. When the determination result indicates that the customer ID stored in the DB is matched with the RFID card number and the personal identification code, the digital information providing server 32 retrieves advertisement information, matched with the advertisement information identification code registered in the card reader 22, from the DB and transmits the retrieved information to the information storage place 12 designated by the customer, in steps S262 and S264. When the catalogue contents are completely transmitted, the number of times that the card reader is touched is counted, and the touch count is updated by the digital information providing server 32, and simultaneously transmitted to the advertiser terminal and noticed to the advertiser through the alarm unit 62, in steps S266 and S268. The alarm unit 62 is a selective component, and the advertiser can check the touch count through the server in real time in step S270.

Next, the detailed process of the customer terminal will be described with reference to FIG. 8.

First, as illustrated in FIG. 8, a customer downloads a member registration app and signs up for membership, when using a mobile terminal, or connects to the server and signs up for membership through a web browser or the like, when using a PC, in steps S302. The customer classifies advertisement contents information in the mobile terminal or the PC, and downloads a dedicated management program to check a list. During the membership sign-up, the customer may input information such as the sex, a receive address, a phone number, an email address and SNS information of the customer.

The member registration app enables the customer to select an advertisement information receiving method, for example, an email, SNS, widget or fax. When signing up for membership through the PC, the customer may execute a dedicated management program or web browser to select the advertisement information receiving method in step S306.

When the customer applies for membership, the customer terminal determines whether an authentication number provided by the digital information providing server 32 is received, in step S308. When the authentication number is not received, the customer tries to sign up for membership again. On the other hand, when the authentication number is received by the customer, the customer assures the server administrator of the authentication number received during the membership sign-up, and the server administrator registers an RFID card through the card registration reader 34, and then provides the RFID card to the customer, in step S310.

The RFID card can be provided for free by a server operating company or purchased through a purchasing place, and registered in the server through the RFID card registration reader 34. The server administrator may register the RFID card by scanning the authentication number through the card registration reader, or directly record and register the authentication number in the server. For another example, when signing up for membership through a PC, the customer may transmit an authentication number to the server. Then, the server administrator may send an RFID card by mail. When the RFID card is purchased from a purchasing place, the customer may input a pin number to the server. In this case, since the server already has an RFID card number corresponding to the pin number, the customer can use the RFID card as soon as the customer inputs the pin number.

Through the operation of registering the RFID card number, the customer can receive advertisement information anytime and anywhere without disclosing the personal information of the customer. Furthermore, when selecting a place for receiving advertisement contents, the customer can easily open and see the advertisement information anytime. During the membership sign-up, the customer inputs, to the server, a method for storing catalogue contents received by the customer, i.e. a storage place such as an email, SNS or widget.

Next, the detailed process of the advertiser terminal will be described with reference to FIG. 9.

As illustrated in FIG. 9, an advertiser connects to the server using a terminal, signs up for membership, and requests advertisement, in steps S402 and S404. The member information of the advertiser may include a company name, a manager name, a phone number, an email address, SNS and the like.

The advertiser registers the unique number of the card reader 22, owned or rented by the advertiser, in the server 32, gives an identification code (ID or P/W) to advertisement information contents, and registers the identification code in the server 32, in steps S406 and S408. The advertiser registers the advertisement information identification code in the card reader 22. After step S408, the advertiser deposits an amount of money for advertisement transmission in the server 32, and determines whether the amount of money is deposited, in step S410. In the embodiment of the present disclosure, a cost per touch may be set for the charge, such that the advertiser can pay for the advertisement fee on a monthly basis. That is, when customers touch the card reader by the number of times corresponding to the deposited amount of money, the advertisement promotion of the month may be ended. Then, the advertisement promotion may be restarted on the first day of the next month. When the deposit of the advertisement fee is checked, the advertiser uploads an advertisement contents matching table and an advertisement contents file to the contents upload unit 46 in step S412. The advertisement contents matching table includes the unique number of the card reader, the advertisement information identification code and the advertisement contents file.

Next, the detailed process of the digital information providing server will be described with reference to FIGS. 10a-1, 10a-2 and 10b.

As illustrated in FIGS. 10a-1, 10a-2 and 10b, the digital information providing server 32 receives a member identification code (ID and P/W), registers the customer as a member, and stores member information in the DB, according to a member registration request from a customer, in step S502. During the member registration of the customer, a dedicated management program is executed to register an advertisement information receiving method inputted by the customer, in step S504.

During the member registration process of the customer in step S502, the digital information providing server 32 generates an authentication number, transmits the authentication number to the customer, and determines whether the authentication number is transmitted to the customer, in step S506. When receiving the authentication number from the customer, the digital information providing server 32 assigns an RFID card number, registers the assigned RFID card number through the RFID card registration reader 34, and stores the RFID card number in the DB, in step S508. When receiving an advertisement information receive request from the customer through such a process, the digital information providing server 32 checks whether the RFID card number and a personal identification code are matched with a personal ID listed on a customer information list stored in the DB.

In the present embodiment, the unique number of the RFID card corresponding to the authentication number is assigned during the member registration of the customer, and registered in the server such that the customer can receive advertisement information registered by all advertisers. Therefore, one RFID card is provided for the identification code of each customer.

After processing the member registration request from the advertiser terminal in step S502, the digital information providing server 32 receives an advertisement contents matching table and an advertisement contents file and stores the advertisement contents matching table and the advertisement contents file in the DB, in step S510. The advertisement contents matching table includes the card reader unique number provided to the advertiser, the advertisement information identification code given by the advertiser, and the advertisement contents file.

When the customer touches the card reader 22 with the RFID card in step S512 after the upload of the advertisement information contents is completed, the digital information providing server 32 receives an advertisement information request from the card reader 22 in step S514. The digital information providing server 32 receives a card reader unique number, an advertisement information identification code and an RFID card number personal identification code, which are inputted from the card reader 22. Then, the digital information providing server 32 checks whether the RFID card number is matched with the customer ID corresponding to the personal identification code, in step S516. At this time, the digital information providing server 32 searches the DB 30 for a customer ID matched with the RFID card number and the personal identification code, and checks whether the RFID card number and the personal identification code are matched with the customer ID. When the check result of step S516 indicates that the RFID card number and the personal identification code are not matched with the customer ID or the RFID card is recognized as a non-registered card, the digital information providing server 32 transmits a usage error to the card reader in step S518. When the check result indicates that the RFID card number and the personal identification code are matched with the customer ID, the digital information providing server 32 checks whether the requested advertisement information is contained in the advertisement contents matching table stored in the DB 30, in step S520. When the check result indicates that the requested advertisement information is contained in the advertisement contents matching table, the digital information providing server 32 retrieves an advertisement contents file matched with the advertisement information identification code from the DB in step S522.

The digital information providing server 32 checks a receiving method (text message, email, SNS or widget) desired by the customer, and transmits the advertisement information to the information storage place 12 designated by the customer, in steps S522 and S524. For example, when the receiving method registered by the customer is the email of the customer, the advertisement contents are transmitted to the email address. The advertisement contents file is stored in a download list of the digital information providing server 32 in step S526.

When the requested advertisement contents are not contained in the advertisement contents matching table, the digital information providing server 32 recognizes that the advertisement service is terminated, and transmits an advertisement service termination text message to the card reader, in step S528. When step S526 is completed, the digital information providing server 32 performs counting by the touch count of the customer, and deducts an amount corresponding to the touch count from the deposit of the advertiser, in step S530.

After step S530, the digital information providing server 32 checks the balance of the card reader to determine whether the deposit balance is equal to or less than a preset amount, in step S532. When the deposit balance is not enough, the digital information providing server 32 controls the reader to generate an alarm in step S534, and requests the advertiser to deposit an amount of money in step S536. When the deposit balance is enough, the digital information providing server 32 continuously waits in a listening mode in step S538.

While various embodiments have been described above, it will be understood to those skilled in the art that the embodiments described are by way of example only. Accordingly, the disclosure described herein should not be limited based on the described embodiments.

1. A system for collecting information by using a digital recognition device, comprising:
a tag information read unit given a unique number for itself, and configured to read tag information;
a tag information input unit having a unique number for itself and personal identification information for receiving digital advertisement information, registered therein;
a customer terminal configured to register personal information of a customer and a customer identification code (ID and P/W), which are required for membership sign-up, in a digital information providing server;
an advertiser terminal configured to generate an identification code (ID and P/W) based on personal information of an advertiser and an advertiser identification code (ID and P/W), which are required for membership sign-up to provide advertisement information to the customer, the unique number of the tag information read unit, and advertisement information contents owned by the advertiser, register the identification code in the digital information providing server, upload the advertisement information contents to the digital information providing server, and deposit an amount of money for advertisement information transmission cost into the digital information providing server;
a DB (Database) configured to store the unique number given to the tag information read unit, the unique number of the tag information input unit, the personal information of the customer, the customer identification code (ID and P/W), the identification code (ID and P/W) given to the advertisement information, the personal information of the advertiser, the advertiser identification code (ID and P/W), an advertisement contents matching table for matching the advertisement information identification code with an index table of advertisement contents, and the advertisement contents; and
the digital information providing server configured to register the identification codes of the customer and the advertiser, the unique number of the card reader and the identification code of the advertisement information therein, assign the unit number of the tag information input unit to the customer, receive the unique number of the tag information read unit, the identification code of the advertisement information registered in the tag information read unit, the unique number of the tag information input unit, and the personal identification code, as the customer touches the tag information read unit with the tag information input unit, request a customer information list from the DB to check whether the unique number of the tag information input unit and the customer identification code which are provided by the tag information read unit are matched with a customer ID, retrieve advertisement information matched with the advertisement information identification code from the DB, provide the retrieved advertisement information to the customer, and deduct an advertisement cost from the amount of money deposited by the advertiser.

2. The system of claim 1, further comprising a tag information input unit registration reader configured to assign the unique number of the tag information input unit and register the unique number in the digital information providing server, when the customer requests member registration.

3. The system of claim 1, further comprising a GPS (Global Positioning System) configured to provide position information of the tag information input unit to the digital information providing server.

4. The system of claim 1, wherein the digital information read unit is any one selected among an RFID reader, an NFC (Near Field Communication) reader, a barcode reader, a QR code reader, an iris recognition device, a fingerprint recognition device and a hologram recognition device.

5. The system of claim 4, wherein the tag information input unit registration reader is any one selected among an RFID card, an NFC card, a barcode, a QR code, iris recognition, fingerprint recognition and hologram.

6. The system of claim 1, wherein the digital information providing server comprises:
an advertiser member registration unit configured to receive an advertisement request from the advertiser terminal and register an advertiser member;
an amount deposit unit configured to request the advertiser to deposit an amount of money for advertisement, in order to charge the advertiser for advertisement provision after the advertiser member registration is completed by the advertiser member registration unit;
a contents upload unit configured to upload an advertisement information identification code (ID and P/W) and advertisement information contents corresponding to the advertisement information identification code, after the amount deposit unit checks that the amount of money is deposited;
a matching unit configured to check whether a customer identification code stored in the DB is matched with the personal identification code and the unique number of the tag information input unit, received through the tag information read unit, as the customer touches the tag information read unit with the tag information input unit, and check whether the advertisement contents matching table stored in the DB is matched with the unique number of the tag information read unit and the advertisement information identification code;
an advertisement contents transmitting unit configured to retrieve requested advertisement information contents from the advertisement contents matching table of the DB, and transmit the retrieved advertisement information contents to the customer, when the matching unit checks that the advertisement contents matching table is matched with the unique number of the tag information read unit and the advertisement information identification code;
a customer member registration unit configured to perform member registration according to a member registration request of the customer;
a tag information input unit registration unit configured to register the unique number of the tag information input unit when the customer signs up for membership, and register the tag information input unit through an tag information input unit registration reader by matching the unique number of the tag information input unit with an authentication number provided to the customer terminal;
a download list storage unit configured to store advertisement information which is downloaded as the customer touches the tag information read unit with the tag information input unit, and classify the advertisement information for each information type;
a central control unit configured to store, in the DB, the identification codes (ID and P/W) given during the membership sign-up of the advertiser and the customer, the unique number of the tag information input unit, the unique number of the tag information read unit, the advertisement information identification code, and the advertisement contents matching table in which the advertisement contents corresponding to the advertisement information identification code are indexed, and perform a series of control processes of receiving the tag information input unit unique number provided from the tag information read unit, the personal identification code, the unique number of the tag information read unit, and the advertisement information identification code, check whether the customer identification code stored in the DB is matched with the unique number of the tag information input unit and the personal identification code, and transmit advertisement information to the customer; and
a charge unit configured to perform a charge command from the central control unit when the advertisement information is transmitted to the customer.

7. The system of claim 6, wherein the digital information providing server further comprises an alarm unit configured to perform counting whenever the tag information read unit is touched with the tag information input unit, and inform the advertiser terminal of the count value.

8. A method for collecting information by using a digital recognition device, comprising:
a first step of requesting, by the customer terminal, a digital information providing server to register individual member information;
a second step of selecting an advertisement information receiving method and registering the selected method in the digital information providing server, when the member information of the customer is registered;
a third step of registering a tag information registration unit unique number in the digital information providing server, when the member information of the customer is registered;
a fourth step of requesting, by an advertiser terminal, the digital information providing server to register advertiser member information, requesting advertisement, and depositing an amount of money for advertisement;
a fifth step of inputting the unique number of a tag information read unit, an advertisement information recognition code, the unique number of a tag information input unit, and a personal identification code, stored in the tag information read unit, to the digital information providing server, when the tag information read unit is touched with the tag information input unit carried by a customer, wherein the digital information providing server determines whether customer information stored in a DB is matched with the tag information input unit unique number and the personal identification code; and
a sixth step of transmitting an advertisement contents file to a storage place designated by the customer, when the customer information is matched with the tag information input unit unique number in the fifth step.

9. The method of claim 8, wherein the first step comprises:
a first process of downloading, by the customer, a member registration app to register the member information, when the customer uses a mobile terminal, or connecting to the server to register the member information, when the customer uses a PC (Personal Computer);
a second process of inputting, by the customer, the tag information input unit unique number, matched with an authentication number provided to the customer terminal, to a tag information input unit registration reader, when the customer registers the member information; and
a third process of registering the tag information input unit unique number, provided from the tag information input unit registration reader, in the digital information providing server, and storing the tag information input unit unique number in the DB.

10. The method of claim 8, wherein the third step comprises downloading a dedicated management program, and executing the dedicated management program to decide a catalogue receiving method, wherein the catalogue receiving method comprises designating a receiving path through which a catalogue is transmitted to a storage place selected among an email, SNS and a widget program.

11. The method of claim 8, wherein the fourth step comprises:
a fourth process of transmitting, by the advertiser terminal, an advertisement request to the digital information providing server, and then giving an identification code (ID and P/W) to advertisement information contents;
a fifth process of registering the identification code (ID and P/W) of the advertisement information contents and the unique number given to the tag information read unit in the digital information providing server; and
a sixth process of depositing the amount of money to be consumed as an advertisement fee, and uploading the advertisement information contents.

12. The method of claim 8, wherein the fifth step further comprises:
a seventh process of receiving member information (ID and P/W) according to a member registration request from the customer, performing member registration, and storing the member information (ID and P/W) in the DB;
an eighth process of assigning a tag information input unit unique number when the member registration of the customer is completed, and matching the tag information input unit unique number with an authentication number provided from the customer to register the tag information input unit unique number in the server;
a ninth process of completely registering a tag information read unit identification code provided from the advertiser terminal, and storing advertisement contents, uploaded by the advertiser, in the DB;
a tenth process of transmitting, by the tag information read unit, the unique number thereof, an identification code given to the advertisement information, the tag information input unit unique number and the personal identification code to the server, when the customer touches the tag information read unit with the tag information input unit;
an 11th process of checking whether the received tag information input unit unique number and the received personal identification code are matched with the customer information, checking an advertisement contents file from an advertisement contents matching table when the tag information input unit unique number and the personal identification code are matched with the customer information, transmitting the advertisement contents to a storage place designated by the customer, transmitting the advertisement contents to a storage place designated by the customer, and transmitting an advertisement service termination text message to the tag information read unit when there is no advertisement contents file; and
a 12th process of performing counting by the touch count of the customer, and deducting an amount corresponding to the touch count from the amount of money deposited by the advertiser.

13. The method of claim 12, further comprising a 13th process of checking the balance of the tag information read unit, controlling the tag information read unit to generate an alarm when the balance is not enough, and providing the advertiser with information indicating that money needs to be additionally deposited.

14. The method of claim 12, wherein the tenth process further comprises a process of checking, by the server, whether a customer ID is matched with the tag information input unit unique number, checking a receiving method desired by the customer, and transmitting advertisement information.

15. The method of claim 8, further comprising a seventh step of counting the number of times that the card reader is touched, and transmitting the count value to the advertisement terminal, after the sixth step.

16. The method of claim 15, wherein the seventh step further comprises an eighth step of transmitting the touch count to the advertiser terminal with an alarm.
